(19) United States
(12) Patent Application Publication
(10) Pub. No.: US 2003/0218528 A1
(43) Pub. Date: Nov. 27, 2003

(54) Current-limiting fuse and housing arrangement

(76) Inventors: Mark W. Stavnes, Des Plaines, IL (US); Glenn R. Borchardt, Round Lake Beach, IL (US); Jorge R. Montante, Cicero, IL (US); Raymond P. O'Leary, Evanston, IL (US); Martin A. Warszawa, Arlington Heights, IL (US)

Correspondence Address: James V. Lapacek, S & C Electric Co., 6601 N. Ridge Blvd., Chicago, IL, 60626, US

(21) Appl. No.: 10/268,252

(22) Filed: Oct. 9, 2002

Related U.S. Application Data
(60) Provisional application No. 60/350,520, filed on Oct. 22, 2001.

(51) Int. Cl. H01H 85/055

(52) U.S. Cl. 337/159; 337/186

(57) ABSTRACT

A current-limiting device is provided that defines a cavity of predetermined dimensions and an elongated circuitous path through the cavity. The device also includes provisions for supporting a current-limiting fusible element along the path. The cavity is filled with a pulverulent arc-quenching filler material. To increase the heat-withstand capabilities of the current-limiting device, heat withstand facilities are provided between the portions of the circuitous path to maximize the length of the path while minimizing the corresponding volume of the device, e.g. via heat resistant materials, the addition of heat shielding materials to the cavity-defining device structure or the structure of support portions of the cavity-defining structure. In one specific arrangement, the path of the fusible element is defined by one or more U-shaped sections. The fusible element includes a configuration of steps or bends along its length to maximize the path length of the fusible element.

### BACKGROUND OF THE INVENTION

1. Field of the Invention

The present invention relates generally to the field of current-limiting fuses for electrical power distribution systems and more particularly to an improved current limiter and housing arrangement that provides an overall small, low-profile housing configuration that is desirable both from the manufacturing and product use perspectives.

2. Description of Related Art

Various current-limiting fuse arrangements are known in the prior art including a variety of housing configurations and a variety of current-limiting fusible elements having predetermined hole patterns and ribbon geometry. For example, see U.S. Pat. Nos. 5,604,475 and 5,502,427.

While the prior art arrangements may be generally useful as current-limiting devices for the electrical distribution field, it is desirable to provide devices with more optimized housing dimensions, configurations, and overall volumes which offer ease and economy of manufacturing.

### SUMMARY OF THE INVENTION

Accordingly, it is a principal object of the present invention to provide a current-limiting device in an optimized configuration having a low volume including a path for a current-limiting element that is much longer than the length and width of the device.

It is another object of the present invention to provide a current limiter in a small low-profile housing configuration having an elongated fusible element within a fulgarite forming material, increased heat withstand facilities being provided to minimize the volume of the housing while still providing a housing that is easy to manufacture.

These and other objects of the present invention are efficiently achieved by the provision of a current-limiting device that defines a cavity of predetermined dimensions and an elongated circuitous path through the cavity. The device also includes provisions for supporting a current-limiting fusible element along the path. The cavity is filled with a pulverulent are-quenching filler material. To increase the heat-withstand capabilities of the current-limiting device, heat withstand facilities are provided between the portions of the circuitous path to maximize the length of the path while minimizing the corresponding volume of the device, e.g. via heat resistant materials, the addition of heat shielding materials to the cavity-defining device structure or the structure of support portions of the cavity-defining structure. In one specific arrangement, the path of the fusible element is defined by one or more U-shaped sections. The fusible element includes a configuration of steps or bends along its length to maximize the path length of the fusible element.

### BRIEF DESCRIPTION OF THE DRAVVING

The invention, both as to its organization and method of operation, together with further objects and advantages thereof, will best be understood by reference to the specification taken in conjunction with the accompanying drawing in which:

FIG. 1 is an elevational view of the fuse arrangement of the present invention;

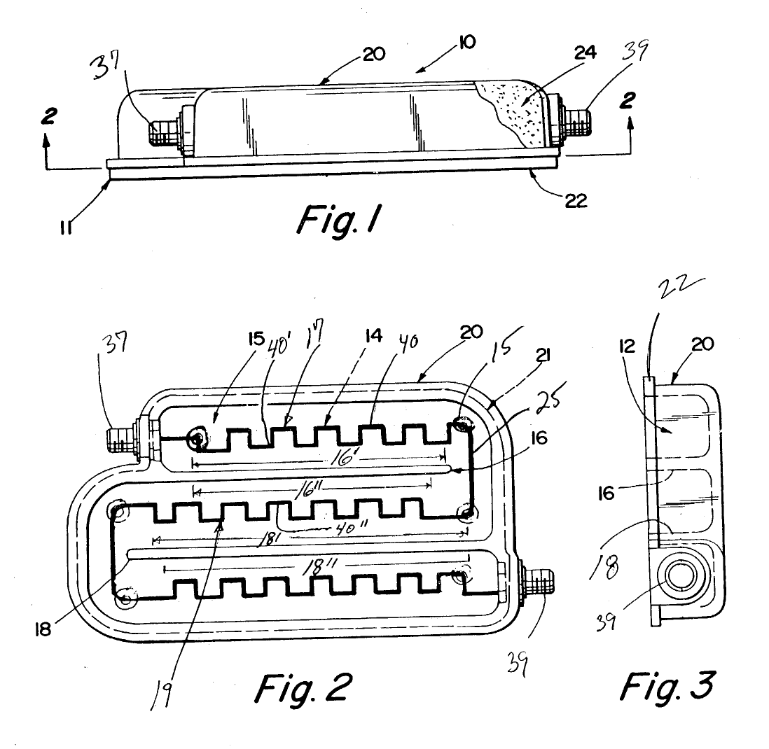

FIG. 2 is a bottom plan view with parts removed of the fuse arrangement of FIG. 1 taken along the line 2-2 of FIG. 1;

FIG. 3 is a right-side elevational view of the fuse arrangement of FIG. 1;

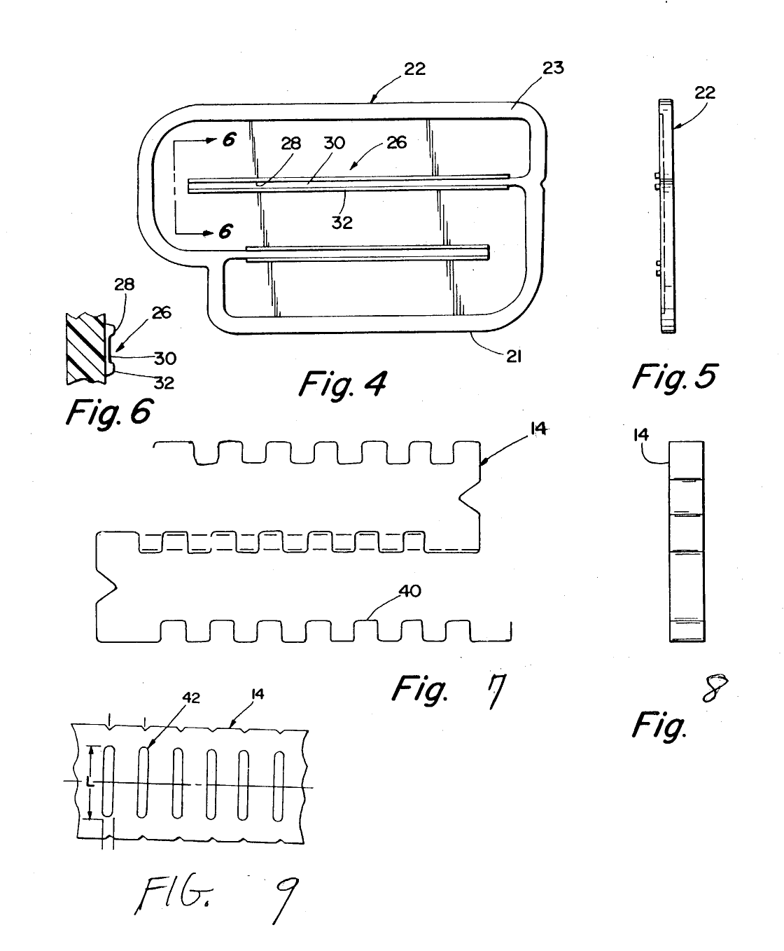

FIG. 4 is an elevational view of a cover portion of the fuse arrangement for use with the assembly of FIGS. 1-3 and as shown in FIG. 1;

FIG. 5 is a right-side elevational view of the cover portion of FIG. 4;

FIG. 6 is a partial sectional view taken generally along the line 6-6 of FIG. 4;

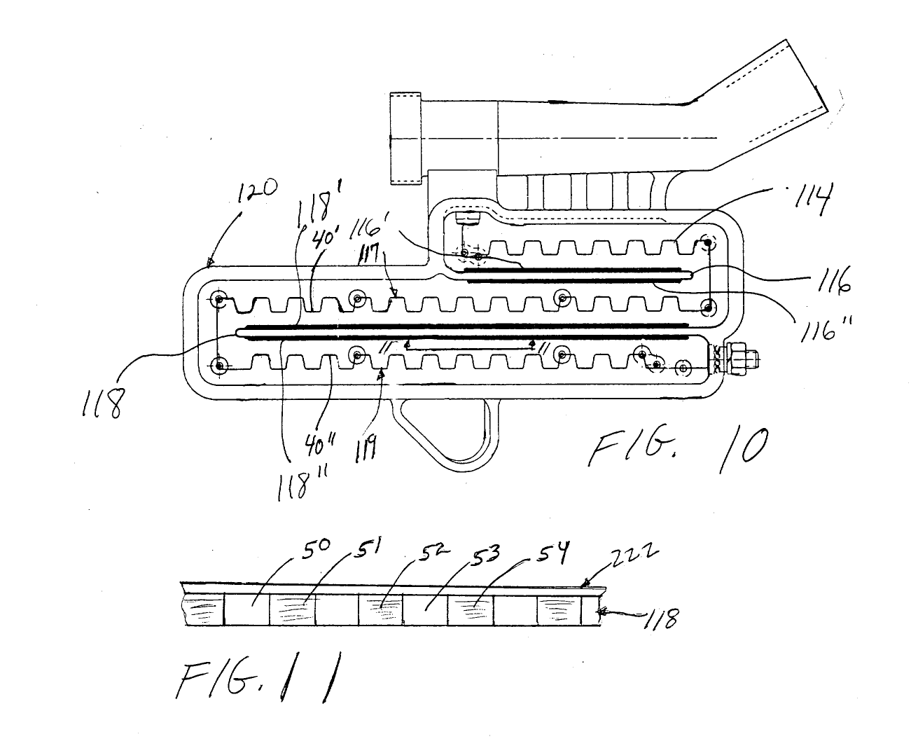

FIGS. 7 and 8 are respective top plan and right-side elevational views of an elongated fusible element usable with and shown in the fuse arrangement of FIG. 2;

FIG. 9 is a partial top elevational view on an enlarged scale of portions of the fusible element of FIG. 7;

FIG. 10 is an elevational view of another embodiment of a fuse arrangement of the present invention;

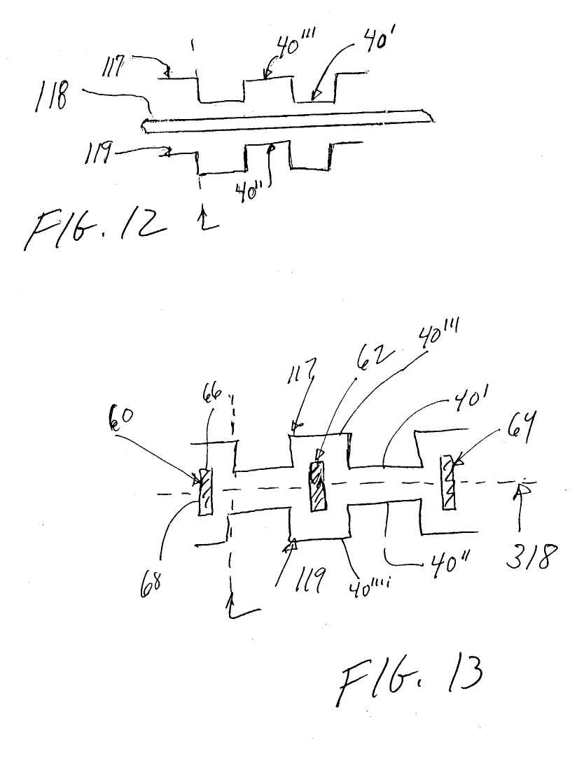

FIG. 11 is an enlarged, partial elevational view of portions of FIG. 7 taken generally from the line 8-8 of FIG. 2 and illustrating an alternate embodiment of the fuse arrangement of FIG. 10;

FIG. 12 is an enlarged, partial view of the fusible element of FIG. 10; and

FIG. 13 is an enlarged view of portions of the fuse arrangement of FIG. 10 and illustrating an alternate embodiment.

### DETAILED DESCRIPTION

Referring now to FIGS. 1-5 and a specific, illustrative example of the present invention, the fuse arrangement 10 includes a housing arrangement 11 for defining a cavity 12, an elongated circuitous path through the cavity, and provisions (generally referred to at 15) for supporting an elongated fusible element 14 along the circuitous path. In a preferred arrangement, the housing arrangement 11 also includes provisions for defining barrier walls, e.g. 16, 18 within the cavity 12 defining cavity sections between portions of the circuitous path. In a specific embodiment as shown in FIGS. 15, the housing arrangement is fabricated from the assembly of two individual housing portions, a first portion 20 and a second portion 22. However, it should be realized that in alternate embodiments the housing arrangement 11 is provided as a single element. Regarding a preferred method for the general manufacture of the specific arrangement illustrated, the elongated fusible element 14 is disposed along the defined path in the first portion 20. The elongated fusible element 14 is fabricated and dimensioned along with the supporting provisions 15 and the path defined by the housing portion 20 such that a desired amount of spring tension exists in the fusible element in the assembled position during fabrication. The cavity 12 is then filled with a pulverulent are-quenching, fulgarite-forming filler material 24. The second portion 22 is then affixed to the first portion 20, with the material 24 being appropriately compacted for desirable performance to form fulgarites and quench arcs thereby during fuse operation when the fusible element carries currents above predetermined levels. The strength of the portions 20, 22 forming the housing arrangement 11 as well as the attachment there between must be sufficient to withstand the temperatures and forces experienced during current-limiting operation and circuit interruption. In an alternate method of fabrication, the housing arrangement 11 is formed, such as in a molding process, as a single component so as to define the portions 20, 22 about the fusible element 14. While the specific illustrative housing arrangement 11 shown in FIGS. 1-5 is low-profile (i.e. a generally flat polyhedron) that is desirable from the manufacturing and product use standpoints, it should be realized that the present invention, in alternate embodiments, is applicable to provide various other path geometries and housing configurations.

The barrier walls 16, 18 of the first portion 20 cooperate with the second portion 22 to provide additional strength and rigidity to withstand the pressure during current limiting and current interruption operation. In a preferred embodiment, the second portion 22 includes defined provisions at 26 for alignment and cooperation with each of the barrier walls 16, 18. Specifically, the provisions include a defined channel 28 formed between two protruding walls or ridges 30, 32. During assembly, the top portions of the barrier walls 16, 18 are affixed or joined to the walls 30, 32 and the surface of the channel at 28 to provide additional rigidity and strength as well as dielectric strength. The dimensions of the barrier walls 16,18 and the features 28, 30 and 32 are arranged so that the barrier walls 16,18 frictionally fit within the ridges 28, 32 and contact the channel surface at 30 during assembly at the same time the outer rims 21, 23 of the housing portions 20, 22 respectively come into contact. The fusible element 14 is connected at its end points to respective terminal connectors 37, 39 to provide external electrical interconnections of the fuse arrangement 10 to suitable mating circuit or device connectors (not shown) of the circuit in which the fuse arrangement 10 is utilized. The ends of the fusible element 14 are suitably affixed and electrically connected to the terminal connectors 37, 39 via resistance welding, ultrasonic bonding, soldering or other suitable process. Preferably, the terminal connectors 37, 39 are incorporated into the fuse arrangement 10 during the molding of the overall fuse arrangement 10. In order to isolate the interior of the fuse arrangement 10 from the environment and to contain internally generated pressure and gas during fuse operation, sealing provisions (not shown) are provided at the interface of the terminal connectors 37, 39 and the housing portion 20 so as to form a seal at the time of fabrication during the molding process.

In accordance with important aspects of the present invention, the barrier walls 16, 18 at respective portions 16′, 16″, 18′ and 18″ are provided with increased heat withstand capabilities to allow the spaced apart portions, e.g. at 17, 19, of the elongated path of the fusible element 14 to be more closely spaced which provides additional length of path and element per unit space and a smaller overall size of the fuse arrangement 10; the portions 16′, 16″, 18′ and 18″ indicating approximate portions of an illustrative example and not to be interpreted in any limiting sense. The barrier walls 16, 18 of the fuse arrangement in are subjected to the highest heat concentrations due in large part to the presence and proximity of the portions of the fusible element 14 on either side of these barrier walls. The term heat withstand capabilities is intended to include the functions and features of heat insulating and heat resistant properties and is not intended to be interpreted in any limiting sense. Thus, the spacing of the path segments can be determined and controlled in accordance with the area and volume of fulgarite-forming filler material that is required by the particular current-limiting function (in combination with the mechanical and thermal strengths and capabilities of the other portions of the housing arrangement 11) and is not limited by thermal withstand or heat resistance of the material of the housing arrangement 11, i.e. without the increased heat resistance or heat withstand capabilities of the barrier wall portions at 16′, 16″, 18′, and 18″ the path sections 17, 19 would be less closely spaced than illustrated in FIG. 2. For example, in one specific embodiment, the increased heat withstand capabilities are provided via the application of a high temperature ceramic cement on the portions 16′, 16″, 18′ and 18″.

In the illustrative embodiment of the present invention of FIGS. 1-5, it can be seen that the path is formed of generally U-shaped sections, i.e. each U-shaped section including two generally parallel legs or path segments, e.g. 17, 19 spanned by a bight 20 portion, e.g. 25, such that each of the generally parallel legs substantially spans the one of the major length or width dimensions of the housing arrangement 11. Thus the path length is much longer then the length or width, or the sum of the length and width of the housing arrangement 11. The present invention can also be practiced with paths and housings of diverse geometries. For example, the path of the fusible element 14 can be characterized as a plurality of serially interconnected non-aligned segments. While it is desirable from the standpoint of practical and efficient fabrication of the housing for the segments to generally define a plane, the invention can be suitably practiced without this constraint.

With additional reference now to FIGS. 7-9, the fusible element 14 is an elongated, thin, conductive ribbon having a predetermined pattern of areas of reduced cross-section formed, for example, by holes 42, at which arcs are formed during current-limiting action and fault-current interruption as is well known to those skilled in the art. In a preferred arrangement and in accordance with important aspects of the present invention, in addition to the fusible element 14 being arranged in an elongated circuitous path as discussed hereinbefore, the fusible element 14 is also arranged to have a plurality of closely spaced departures from or bends along the path to substantially increase the length thereof. In a preferred arrangement, theses bends or departures, referred to as projections 40 hereafter, are generally rectangular-shaped and arranged to form a path of contiguous or adjacent departures 40, i.e. two right angle bends in the same direction followed by two right angle bends in the opposite direction. These “tooth-like” projections 40 may also be characterized as extending generally perpendicularly away from the segments 17, 19 of the fusible element 14. Further, each projection 40 can also be characterized as being provided by four bends out of a straight path and having two included angles that are approximately right angles. In FIG. 2, the projections 40′ and 40″ illustrate the portions of the segments 17, 19 that approach most closely to the barrier wall 16.

For example, via these projections 40, a fusible element 14 of total ribbon length in the range of 30 inches occupies a path length in the device 10 in the approximate range of 12 inches. This arrangement, in addition to increasing the path length of the fusible element 14, has also been found to increase current-limiting action, especially in combination with a close spacing of the areas of reduced cross-section. That is, for the same length of fusible element 14, a straight arrangement exhibits a higher let-through energy (1²t) as compared to the pattern of bends 40 such that a longer fusible element 14 is required to achieve the same let-through effects as the pattern of bends 40. Thus, this feature synergistically reduces the path length measured through the housing 11, first due to the extra length of fusible element used in the bends 40 out of the straight line path, and secondly, the pattern of bends 40 lowers the let-through rating as compared to the same length of fusible element material disposed in a straight line path.

Additionally, a close spacing of the areas of reduced cross-section minimizes the size of fulgarite growth and results in fulgarite formations or sites that are uniform in cross-section and smaller in any one dimension. This allows for a smaller dimension of fulgarite material and thus a smaller size and volume of the housing 11. As an illustrative example as shown in FIGS. 7-9, a fusible element 14 fabricated from hard temper ETP copper has been found suitable for use with a standard 20K cutout fuse link of (20 ampere rating with K speed TCC). The housing portions 20, 22 are preferably fabricated from a long glass fiber reinforced thermoplastic or polymer composite material that is suitable for injection molding of the portions 20, 22. While the term long fiber is used, this is not to be confused with a continuous fiber process. A length of fiber of approximately ½ of an inch has been found suitable for injection molding while achieving approximately 98% of the strength of a long-fiber continuous process. Examples of materials that are suitable for this type of molding are polyphthalamide, polyethylene terephthalates, polyamides, polyetherimides, etc. 10 Devices of this general type are available from S&C Electric Company, Chicago, Ill. 60626, under the tradename Fault Tamer® Limiter Assemblies for operation to interrupt currents in excess of 10,000 amperes at voltages in the range of 10-38 kV RMS. Reference may be made to the aforementioned U.S. Pat. Nos. 5,604,475 and 5,502,427 for additional details of the fabrication of the housing arrangement 11.

Referring now additionally to FIG. 10 to illustrate an alternate embodiment of the present invention, a housing portion 120 with a fusible element 114 for 38 kV operation is illustrated of the type shown in the aforementioned U.S. Pat. No. 5,502,427. In this alternate embodiment, the desired heat withstand capabilities are obtained via the addition of heat insulating material in the form of strips 116′, 116″, 118′ and 118″ of heat resistant material as indicated on the respective barrier walls 116, 118, i.e. the strips 116′, 116″, 118′ and 118″ functioning as heat resistant shields to shield the barrier walls 116, 118 from excessive heat during operation for a sufficient time for the heat to dissipate elsewhere. The layers 116′, 116″, 118′ and 118″ are suitably fastened to the respective barrier walls 116, 118 via cement or any other suitable fastening technique. In a specific embodiment, the strips 116′, 116″, 118′ and 118″ are fabricated from mica.

In accordance with other aspects of the present invention and referring now additionally to FIG. 11, in a specific embodiment, the barrier walls 116, 118 of FIG. 10 referred to at 216, 218 in FIG. 11, are formed with spaces or gaps 50, 52, 54 etc. that along with a second or cover portion 222 define window-like openings in the barrier walls 116, 118 of FIG. 10. This configuration aids in heat dissipation and reduces the heat concentrations at the barrier walls 116, 118, e.g. due to the proximity of the portions 40′, 40″ of the path segments 117, 119 of the fusible element 114 that are closest to the barrier wall 118. In one specific arrangement, the openings 50, 52 are aligned with the portions 117, 119 of the fusible element 114 that are in closest proximity to the barrier wall 118. Depending upon the relative ratio of the size of the openings 50, 52 and intermediate wall portions 51, 53 as further dictated by the strength requirements of the housing configuration 11, the barrier walls 216, 218 can also be characterized in terms of the support portions 51, 53 rather than in terms of the openings 50, 52 defined therebetween, the support portions 51, 53 being placed as required to obtain the desired strength of the housing configuration 11. It should be understood that while the openings 50, 52 are illustrated with respect to the configuration of FIG. 7 shown with the strips 116′, 116″, 118′ and 118″, the present invention utilizing the configuration of barrier walls 216, 218 may also be practiced in connection without the strips 116′, 116″, 118′ and 118″.

In accordance with additional important aspects of the present invention and referring now additionally to FIG. 12, in order to balance the heat concentrations on the barrier wall, e.g. barrier wall 118 of the housing portion 120 of FIG. 10, the fusible element 114 is arranged within the housing portion 120 such that the projections 40′ of the segment 117 and 40″ of the segment 119 that most closely approach the barrier wall 118 are offset from each other, i.e. the projections 40 of each of the segments 117, 119 are aligned with the projections such as 40″ and 40′″ extending in the same direction within the housing portion 120. Again, this feature may be implemented with or without the strips 116′, 116″, 118′ and 118″.

With additional reference now to FIG. 13 and in accordance with further important aspects of the present invention, in another alternate embodiment the projections 40 of the segments 117, 119 of the fusible element 114 are arranged such that the projection 40′ of the segment 117 and the projection 40″ of the path segment 119 that most closely approach each other are aligned along the wall axis 318, i.e. project toward each other, e.g. at 40′, 40″, at the same locations and then away from each other, e.g. at 40′″, 40″″. Further, in lieu of the wall 118, support members or portions, e.g. 60, 62, 64, are utilized where the projections 40 are farthest apart, the support portions 60, 62, 64 extending from the bottom of the housing portion 120 to the top housing portion, e.g. as illustrated by the wall 18 in FIG. 3. This configuration reduces the heat concentration and also reduces the amount of material along the wall axis 318. As shown in FIG. 13, to minimize heat concentration on the material of the support portions 60, 62, 64 while providing the most support to the housing portion 120, the support portions 60, 62, 64 include a rectangular cross-section having a length 66 greater than a width 68 which maximizes the distance from the fusible element 114.

While there have been illustrated and described various embodiments of the present invention, it will be apparent that various changes and modifications will occur to those skilled in the art. Accordingly, it is intended in the appended claims to cover all such changes and modifications that fall within the true spirit and scope of the present invention.

1. In a current-limiting fuse having a housing and an elongated fusible element disposed therethrough in a circuitous path, the improvement comprising the application of heat resistant facilities intermediate predetermined portions of the fusible element and predetermined portions of the housing to reduce heat stress concentrations on the predetermined portions of the housing.

2. A current-limiting fuse comprising:
housing means for defining a cavity of predetermined dimensions;
an elongated fusible element;
means for defining an elongated circuitous path through said cavity and for supporting said elongated fusible element along said elongated circuitous path; and
pulverulent arc-quenching filler material surrounding said elongated fusible element and generally filling said cavity, said housing means defining one or more upstanding wall members within the cavity and heat-shielding means disposed over predetermined portions of said one or more upstanding wall members in the vicinity of predetermined portions of said elongated fusible element to increase the overall heat withstand capability of the current-limiting fuse.

3. The current-limiting fuse of claim 2 wherein said heat-shielding means comprises a high temperature ceramic cement being applied to said predetermined portions of said one or more upstanding wall members.

4. A current-limiting fuse comprising:
housing means being a generally flat polyhedron comprising at least two housing portions for defining a cavity of predetermined dimensions having overall length L, width W, and height H;
first means for defining an elongated circuitous path through said cavity, said elongated circuitous path including two or more U-shaped path portions, each of said U-shaped path portions including two generally parallel legs spanned by a bight portion;
an elongated fusible element being disposed along said elongated circuitous path;
second means for electrically connecting said elongated fusible element to at least two points on the periphery of said housing means;
pulverulent arc-quenching filler material surrounding said elongated fusible element and generally filling said cavity, one of said housing portions comprising upstanding wall members arranged between said generally parallel legs of the elongated circuitous path; and
third means for increasing the heat-withstand capabilities of the current-limiting fuse comprising increasing the heat-resistant properties of predetermined portions of said upstanding wall members.

5. The current-limiting fuse of claim 4 wherein said third means comprises heat-shielding material being affixed to said predetermined portions of said upstnaeding wall members.

6. An arrangement for maximizing the length of a path for a fusible ribbon within a low-profile housing that has generally planar top and bottom surfaces that are generally parallel, the arrangement comprising means for defining a path formed by a plurality of serially connected segments which are all generally in the same plane and wherein successive segments are defined by a change in direction to define a circuitous path that weaves its way through said low-profile housing, said path being further defined by tooth-like departures of said fusible ribbon extending generally perpendicular away from said segments, and means for increasing the heat-resistant properties of the housing in areas of heat concentration resulting from the proximity of the fusible ribbon.

7. An arrangement for maximizing the length of a path for a fusible ribbon within a low-profile housing that has generally planar top and bottom surfaces that are generally parallel, the arrangement comprising means for defining a path formed by a plurality of serially connected segments which are all generally in the same plane and wherein successive segments are defined by a change in direction to define a circuitous path that weaves its way through said low-profile housing, said path being further defined by tooth-like departures of said fusible ribbon extending generally perpendicular away from said segments, said tooth-like departures in adjacent ones of said plurality of serially connected segments being aligned with each other such that said tooth-like departures extend in the same direction.

8. An arrangement for maximizing the length of a path for a fusible ribbon within a low-profile housing that has generally planar top and bottom surfaces that are generally parallel, the arrangement comprising means for defining a path formed by a plurality of serially connected segments which are all generally in the same plane and wherein successive segments are defined by a change in direction to define a circuitous path that weaves its way through said low-profile housing, said path being further defined by tooth-like departures of said fusible ribbon extending generally perpendicular away from said segments, said tooth-like departures in adjacent ones of said plurality of serially connected segments being aligned with each other but extending oppositely to each other such that said tooth-like departures extend in opposite directions.

9. A current-limiting fuse comprising:
housing means comprising at least two housing portions for defining a cavity of predetermined dimensions;
first means for defining an elongated circuitous path through said cavity, said elongated circuitous path including two or more U-shaped path portions, each of said U-shaped path portions including two generally parallel legs spanned by a bight portion;
an elongated fusible element being disposed along said elongated circuitous path, said elongated fusible element including tooth-like departures extending generally perpendicular away from said elongated circuitous path, said tooth-like departures in adjacent portions of the elongated circuitous path being aligned with each other but extending oppositely to each other such that said tooth-like departures extend in opposite directions; and
pulverulent arc-quenching filler material surrounding said elongated fusible element and generally filling said cavity, said housing means comprising strengthening means extending between the two housing portions and arranged between said parallel legs of said U-shaped path portions, said strengthening means comprising a predetermined pattern of support members arranged for maximum clearance from said tooth-like departures.
